(19) United States
(12) Patent Application Publication
(10) Pub. No.: US 2015/0079833 A1
(43) Pub. Date: Mar. 19, 2015

(54) Electrical connector-to-receptacle retainer

(71) Applicant: Frank E. Bunn, Thornhill (CA)

(72) Inventor: Frank E. Bunn, Thornhill (CA)

(21) Appl. No.: 14/031,200

(22) Filed: Sep. 19, 2013

(51) Int. Cl. H01R 13/627

(52) U.S. Cl. CPC H01R 13/6275
USPC 439/352

(57) ABSTRACT

An electrical connector-to-receptacle, sometimes called plug-to-socket, retainer means for maintaining firm electrical connection of a connector, sometimes called a plug, attached to a receptacle, sometimes called a socket, is comprised of a physical means attached to the connector and attached to the receptacle thereby restraining the connector from disengaging from the receptacle. This retainer means can be fabricated as either a one-piece or multiple-piece means that can be firmly attached to the connector and firmly attached to the receptacle such that, when attached, the retainer means prevents the connector from withdrawing from the receptacle. Additionally, a securing means is incorporated into the retainer thereby permitting the insertion of the connector into the receptacle or the removal of the connector from the receptacle as desired while the retaining means is still firmly attached to the connector and to the receptacle. The retainer means is a device completely separate from the connector and from the receptacle and is only physically attached or detached from an existing connector and from an existing receptacle, thereby the retainer means does require modifications or replacement of the existing connector or receptacle.

### BACKGROUND OF THE INVENTION

Electric energy creation and use by the North American public can be traced back to the 1800's as noted in the Wikipedia Encyclopedia reference “Thomas Edison” (1847-1931). Among his many inventions, he “developed a system of electric-power generation and distribution to home and factories—a crucial development in the modern industrialized world.” This distribution system was a direct outcome of his U.S. Pat. No. 223,898 file Nov. 4, 1879 and issued Jan. 27, 1880 for an “Electric—Lamp”. “Edison patented a system for electricity distribution in 1880, which was essential to capitalize on the invention of the electric lamp. On Dec. 17, 1880, Edison founded the Edison Illuminating Company. The company established the first investor-owned electric utility in 1882 on Pearl Street Station, New York City. It was on Sep. 4, 1882, that Edison switched on his Pearl Street generating station's electrical power distribution system, which provided 110 volts direct current (DC) to 59 customers in lower Manhattan.” However, the Wikipedia Encyclopedia reference notes alternating current “AC replaced DC in most instances of generation and power distribution, enormously extending the range and improving the efficiency of power distribution. Though widespread use of DC ultimately lost favor for distribution, it exists today primarily in long-distance high-voltage direct current (HVDC) transmission systems. Low-voltage DC distribution continued to be used in high-density downtown areas for many years but was eventually replaced by AC low-voltage network distribution in many of them.”

Once electric power became available, many inventions were created to use this power source including methods for connecting appliances to the supply of power. Wikipedia Encyclopedia reference “AC Power connectors and receptacles” notes: “Gustav Binswanger, a German immigrant who founded the (British) General Electric Company Ltd, obtained a patent (GB189516898) in 1895 for a connector and receptacle using a concentric (co-axial) contact system. When electricity was first introduced into houses, it was primarily used for lighting. At that time, many electricity companies operated a split-tariff system where the cost of electricity for lighting was lower than that for other purposes. This led to portable appliances (such as vacuum cleaners, electric fans, and hair driers) being connected to light bulb receptacles. An early American electrical connector and receptacle was invented by Harvey Hubbell and patented in 1904. Hubbell's first design screwed into a light receptacle rather than being directly connected to the building's fixed wiring (U.S. Pat. No. 774,250). Other manufacturers adopted the Hubbell pattern and by 1915 they were widespread, though light-receptacle connections for appliances persisted into the 1920s.”

Once the connectors and receptacles became available, a limitation of the electric cord, with a connector inserted into the receptacle delivering power from the receptacle to the appliance, was the length of the cord. Electric extension cords solve this problem by providing a connector attached to one end of an electric cord with a receptacle attached on the other end into which the appliance connector could be inserted at a distance from the receptacle providing the power up to the length of the extension cord. Electric extension cords, however, introduced another problem: the connector of the extension cord could easily be unintentionally disconnected from the receptacle supplying the power or the connector on the appliance could easily be unintentionally disconnected from the extension cord receptacle hence stopping the delivery of the power to the appliance. This problem can occur with an appliance or an extension cord inserted into a receptacle such as but not limited to a stationary wall receptacle. In 1922, U.S. Pat. No. 1,404,098 revealed a special connector which could engage locking hooks in a special receptacle from which the connector could be released by pressing release buttons. There have been many such US patents revealing special connectors for engaging with special receptacles for locking connectors into these receptacles such as U.S. Pat. Nos. 2,002,558; 2,340,822; and 7,407,613. In 1951, U.S. Pat. No. 2,552,061 revealed a special receptacle means to lock a commonly available connector into the receptacle to prevent disconnection. There have been many such US patents revealing special receptacles for locking connectors into these receptacles such as but not limited to: 2,704,831; 2,732,531; 3,710,304; 4,085,991; 4,136,919; 4,312,554; 4,784,611; and 6,682,361. In 1933 U.S. Pat. No. 1,941,374 revealed a special connector using spring loaded friction means to hold the connector locked into a commonly available receptacle. There have been other such patents including but not limited to U.S. Pat. No. 4,544,216 which reveal such locking and releasing means.

Although complex and requiring special connectors or special receptacles or both, there have been many US patents issued for locking means for holding an electric connector into an electric receptacle. The problem with all these devices is that users are required to purchase specialized connectors or receptacles or both and must adapt the existing extension cords and wall receptacles to utilize the devices. The inconvenience, complexity and extra cost involved to utilize these devices have added to the general failure for their adaptation.

The disclosures of this patent solve these failures by revealing an electrical connector to receptacle retainer means for maintaining firm electrical connection of a connector attached to a receptacle. This means is comprised of a physical connecting device that can be attached to any regularly available connector and can be attached to any regularly available receptacle thereby restraining the connector from unintentionally disengaging from the receptacle. This retainer means can attach to commonly available extension cords and receptacles thereby eliminating the need for their replacement. Additionally, this retainer means can eliminate the user frustration and possible safety issues that can be created by the unintentional disconnection of these electric connectors from these power supplying receptacles.

### DETAILED DESCRIPTION OF THE INVENTION

The electric connector-to-receptacle retainer is a unique system means incorporating existing fastening devices and methods integrated with a flexible material, such as but not necessarily limited to an elastic rubber-like strap, to create a simple and effective system for the retention of said connector such as but not limited to a corded electric connector to remain fully engaged with said receptacle such as but not limited to a corded electric receptacle so as to avoid unintentional disconnection of said connector from said receptacle while also providing a simple system with which to disconnect said connector from said receptacle when desired.

FIG. 1 is a schematic representation of the electric connector-to-receptacle retainer means in which for simplicity are illustrated a corded plug type of connector and a corded socket type of receptacle. FIG. 1a) illustrates the connecting retainer means 1), such as a flexible material such as but not necessarily like rubber, in which is included an opening 2), through which a said connector can be inserted and an opening 3), through which a said receptacle can be inserted and in which is included one half of a snap fastener with its female half imbedded 4), on one end of said material and its male half is imbedded 5), on the other end of said material. The male half of a snap fastener will be illustrated with a black center and the female half of a snap fastener will be illustrated with a white center throughout this patent disclosure. The said opening for the said connector is sized to be of appropriate size to allow said material to be stretch over the said connector so that when the connector is inserted through said material, the flexibility of said material will then return to its relaxed condition such that the said material encircles the electric cord of the said corded connector there by holding the cord fast and preventing the connector from unintentionally being pulled back through said opening. Similarly, the said opening for the said receptacle is sized to be of appropriate size to allow said material to be stretch over the said receptacle so that when the receptacle is inserted through said material, the flexibility of said material will then return to its relaxed condition such that the said material encircles the electric cord of the said corded receptacle there by holding the cord fast and preventing the receptacle from unintentionally being pulled back through said opening.

FIG. 1b) illustrates said connector 6), for insertion 7), into said opening 2) of FIG. 1a), by stretching said opening to permit insertion of said connector through said connecting retainer means. FIG. 1b) further illustrates said receptacle 8), for insertion 9), into said opening 3) of FIG. 1a), by stretching said opening to permit insertion of said receptacle through said connecting retainer means. Further, the longitudinal distance between the said opening 2) and opening 3) can be established at a specific distance described below in discussion of FIG. 1d).

FIG. 1c) illustrates the stretching 10), longitudinally 11), of said connecting retainer means material so as to allow the said inserted connector to be mating 12), with the said inserted receptacle. Upon releasing the said stretched said material 13) illustrated in FIG. 1d), the said connector can be fully mated 14) to the said receptacle. The specific distance longitudinally between said openings noted above, can be arranged so that when the said material is released from its said stretched condition 10), that there remains sufficient stretching across the said mated said connector to said receptacle, thereby to provide a force from the elasticity of the said still stretched said material, retaining the said connector fully mated to the said receptacle.

FIG. 1e) illustrates the stretching 15), of the ends of the said material while folding them 16) up and over the said mated connector to said receptacle. While stretching the said ends so that the snap fastener male and female components align, the said snap fastener can be closed thereby fastening said ends together and maintaining the said stretching of the ends over the said mated connector to said receptacle. The said stretched ends of the said material each thereby provides an additional force from the elasticity of the said stretched ends of said material, as it remains stretched and securely fastened by the snap fastener 16), over the said mated connector to said receptacle providing said additional forces retaining the said connector fully mated to the said receptacle. This said additional force adds to the said force provided by the said retention of some of the stretching of the said material as described in FIG. 1c) during the said mating of said connector and said receptacle when said material is released as described in FIG. 1d) when the said connector is fully mated to the said receptacle.

The simplicity of the electric connector-to-receptacle retainer means as described above, is its ease with which the said connector and the said receptacle can be inserted into the said material and snapped firmly together to retain the mating electrical connection of said connector to said receptacle to prevent their unintentional disconnection. Additionally, the electric connector-to-receptacle retaining means can be readily and easily removed from retaining the said connection by unsnapping the said snap fastener and removing the connector from the receptacle. If permanent disconnection is desired, the said corded connector can be withdrawn from the said material by stretching the material over the connector and removing the connector from the material. The said cored receptacle can remain inserted to the said material so that the receptacle is ready to be installed and provide the retaining connection described herein, with the connector on the next appliance needing connection to the said corded receptacle as described in the FIG. 1 discussion.

It will be clear to anyone versed in the technology of fasteners that there are many alternative fasteners that could be employed in place of the openings illustrated in FIG. 1a), and described in the preceding discussion electric connector-to-receptacle retainer means referring to the schematic representation of the FIG. 1. FIG. 2 is a schematic representation of one, but not necessarily the only one, of such an alternative fastener for the electric connector-to-receptacle retainer means by the utilization of hook-and-loop fasteners with the said flexible material.

FIG. 2a) illustrates the connecting retainer means 17) with hook-and-loop fasteners located one 18) on one side 20), and one 19) located on the opposite side 21), of the said flexible material means as described in FIG. 1, and are located in similar positions as were indicated openings in the said material. FIG. 2a) also shows the female 20), and the male 21), components of the snap fasteners similar to those that were located and describe in FIG. 1.

FIG. 2b) illustrates the said connector 22), and its hook-and-loop securing fastener 23), such that the fastener can be raised 24), over the cord of the said corded connector thereby securing it to said material, and FIG. 2b) also illustrates the said receptacle 25) and its hook-and-loop securing fastener 26), such that the fastener can be raised 24), over the cord of the said corded receptacle thereby securing it to said material.

FIG. 2c) illustrates the said connector attached to the said material and said receptacle attached to said material such that stretching 28) longitudinally of the said material 27) thereby allows the said attached connector to be mating 29), to the said attached receptacle.

FIG. 2d) illustrates the said material released from its stretched condition 30), but still with sufficient remaining stretching across the mated said connector and said receptacle 31), to thereby provide a stretched elastic force retaining the said connector fully mated to the said receptacle.

FIG. 2e) illustrates the stretching 35) of the connecting retainer means ends 32) of the said material folding one end 34) up and over 36) the said mated receptacle and connector, and folding the other end 33) up and over the mated connector and receptacle. While stretching the said ends so that the said snap fastener female snap component 20) of FIG. 2a) and snap fastener male snap component 21) of FIG. 2a) align, the said snap fastener can be closed thereby fastening said material ends together and maintaining the said stretching of the ends over the said mated connector to said receptacle. The said stretched ends of the said material each thereby provides an additional force from the elasticity of the said stretched ends of said material, as it remains stretched and securely fastened by the snap fastener over the said mated connector to said receptacle providing these additional forces retaining the said connector fully mated to the said receptacle. These said additional forces add to the said force provided by the said retention of some of the stretching of the said material as described in FIG. 2c) during the said mating of said connector and said receptacle when said material is released as described in FIG. 2d) when the said connector is fully mated to the said receptacle.

Similar to the example of FIG. 1 employing openings in the material, here the use of hook-and-loop fasteners as illustrated in FIG. 2 for the retaining of the connector mated to the receptacle to prevent unintentional disconnection is a simple and easy to use means. And, similarly, the connector can be easily disconnected from the receptacle by opening the snap fastener if so desired, and similarly the connector-to-receptacle retainer means can be removed from the connector while the connector-to-receptacle retainer means is retained on the corded end of the receptacle, and the connector-to-receptacle retainer means can also be removed from the receptacle if desired.

Further it will be clear to anyone versed in the technology of fasteners and material means that, in the examples of the use of snap fasteners illustrated in FIGS. 1, 2, and 3, the snap fastener placed to permit the closing on the ends of the said material over the said connector engaged with the said receptacle to retain their connection could be another type of fastener such as, but not limited to, hook-and-loop fasteners, twist ties, cord ties or other types of fasteners.

Further it will be clear to anyone versed in the technology of fasteners and material means that the said material need not necessarily be elastic but could be flexible such that by careful placement of the fasteners, the said fastening of the material means to the said connector and the said fastening of the material means to the said receptacle could permit the mating of the said connector to the said receptacle and that location of the said fastener components could allow the said raising of the said ends allowing sufficient length of the said flexible material to permit the closing of the said material over the said connector when mated to the said receptacle. As the placement of the said fasteners holding the said connector mated to the said receptacle allows only enough material between the said fasteners to hold the mated connector and receptacle and just enough material to permit the closing of the fastener, the said flexible material being non-elastic will not expand due to the strength of the material and will retain the firm connection of the connector mated with the receptacle.

Further, it will be clear to anyone versed in the technology of fasteners, materials and electrical devices that the electric connector-to-receptacle retainer means revealed herein can be utilized with many types of electrical connectors and receptacles. One such receptacle but not necessarily limited to such, is a wall outlet receptacle and one such connector but not necessarily limited to such, is a corded connector. FIG. 3 is a schematic representation of a two-piece electric connector-to-receptacle retainer means implemented for use with a corded connector engaging with a wall receptacle, here the receptacle being a duplex electrical wall receptacle, which typically employs a wall cover plate with openings for fitting over and leaving exposed the duplex receptacles while said plate fits closely to the wall. These wall cover plates typically have openings to allow access to the two receptacles of the said duplex while safely covering the remainder of the electrical components, mounting box, wiring and opening in the wall that facilitate implementation of the duplex receptacle device.

FIG. 3a) illustrates the connector piece 37), of the flexible connecting retainer means comprising a flexible material such as but not necessarily like rubber, incorporating an opening 38), through which a corded connector 39), has been inserted by stretching the said flexible material of the retainer means over the connector and pulling the connector through similar to the manner described in detailed description involving FIG. 1. One end of the said retainer means connector piece incorporates a male-snap half 40), of a male-female snap fastener and similarly on the other end of said connector piece is incorporated another said male-snap half 41) both of which ends are sufficiently long to permit stretching of the said flexible material, over the said connector.

The receptacle piece 42), of the flexible connecting retainer means illustrated in FIG. 3b), incorporates an opening 44), to facilitate access for engaging of a connector to a wall receptacle 45), herein shown as the upper receptacle of the said duplex. The said receptacle piece includes one female-snap half of a male-female snap fastener incorporated on one end 46), and another female-snap half 47) on the opposite end. The said receptacle piece of the retainer means in this example is illustrated as mounted horizontally in front of the upper receptacle 45) of the said duplex, and behind and secured by the wall cover plate 43) which is fastened to the duplex receptacle with a securing screw 48). The said receptacle piece is to be of such a length to allow the ends to protrude beyond the sides of the wall cover so that the ends are to be able to be stretched over the sides of a connector engaging the receptacle.

The said connector 39) of FIG. 3a) is show 53), in FIG. 3c) as cored 58) and engaging the said receptacle 45) of FIG. 3b) by inserting 53) said connector into said receptacle. After inserting the said connector into said receptacle, each end 54) and 56) of the connector securing retainer means 59) is stretched over the sides of the connector 53), while stretching each of the ends 55) and 57) of the receptacle connecting retainer means 60) so as to align the male snaps 51) and 52) with the female snaps 49) and 50), and allowing the close of the said male to female snaps, one on each side of the connector.

The connector is shown as fully engaged with the said receptacle as illustrated 62), in FIG. 3d). The closed snaps 65) and 66), are illustrated on each side of the connector as the female-snap half appearing as a white oval and the male-snap half appearing as a mated black oval in FIG. 3d). These snap fasteners securing the stretched said material over the said connector piece 63), and of the said stretched said material over said receptacle piece 64), have retained some elasticity of the stretching of the said ends of the receptacle piece retainer means as stretched over the edges of the wall plate and over the stretched ends of the said connector piece, and some of the elasticity of the stretching of the said ends of the connector piece retainer means stretched ends of the connector. The elasticity of maintaining this said stretching creates an elasticity force in the said stretched means so as to retain the said connector fully engaged in the said receptacle.

Further, it will be clear to anyone versed in the technology of fasteners, materials and electrical devices that the electric connector-to-receptacle retainer means reveled herein can utilize materials that are not necessarily flexible, stretchable, or elastic-like materials means reveled herein. The placement of the fasteners to hold an electrical connector fully engaged to an electrical receptacle of the electric connector-to-receptacle retainer means reveled herein can be implemented on such as but not limited to a non-stretchable material means such as but not necessarily a cloth woven material wherein this material can provide the retaining function for holding the connector fully engaged to the receptacle due to this material being non-stretching when closed with fasteners such as but not limited to snap fasteners.

Further, it will be clear to anyone versed in the technology of fasteners, materials and electrical devices that the electric connector-to-receptacle retainer means reveled herein can utilize material means that are not necessarily shaped as a long narrow strap with rounded ends as illustrated in FIGS. 1, 2, and 3, but could be other shapes, such as but not limited to, material means shaped like an “H”. For an “H” shape material means the cross bar of the “H” could be the section of the means retaining the insertion of the connector into the receptacle and the vertical sections of the “H” could incorporate fasteners on one vertical section to hold the material means to the connector and could incorporate fasteners on the other vertical section to hold the material means to the receptacle. It also will be clear that the lengths of the material means and the number and placement of the fasteners and the sizes of the openings can be adapted for differing sized of connectors and receptacles.

### BRIEF DESCRIPTION OF THE DRAWINGS

Embodiments of the invention will now be described by way of example only and for simplicity illustrating a connector as a plug and a receptacle as a socket with reference to the accompanying drawings in which:

FIG. 1 is a schematic representation of the electric connector-to-receptacle retainer means in this example for retaining a corded connector engaging with a corded receptacle and incorporating stretching elasticity of a flexible material of said means and incorporating snap fasteners, comprising:

FIG. 1 a) illustrating the connector-to-receptacle retainer means flexible material through which, a connector can be inserted through an opening and a receptacle can be inserted through a second opening, and including a snap fastener with its male half, illustrated with a black center throughout this patent disclosure, imbedded on one end of said material and its female half, illustrated with a white center throughout this patent disclosure, imbedded on the opposite end of said material; and

FIG. 1b) illustrating the connector-to-receptacle retainer means flexible material through stretching of which a connector can be inserted through an opening sized for the connector on one end and a receptacle can be inserted through a second opening sized for the receptacle on the opposite end for which said openings are located a distance apart such that said flexible material would need to allow sufficient stretching to permit mating of said connector to said receptacle; and

FIG. 1c) illustrating the stretching longitudinally of the connector-to-receptacle retainer means flexible material so as to allow the connector inserted in the material to be mating to the receptacle inserted in the material; and

FIG. 1d) illustrating the connector-to-receptacle retainer means flexible material released from its stretched condition but still with sufficient remaining stretching across the connector mated to the receptacle, thereby to provide a stretched elastic tension force retaining the connector fully mated to the receptacle; and

FIG. 1e) illustrating the stretching of the ends of the connector-to-receptacle retainer means flexible material while folding the ends up and over the mated connector and receptacle and by closing together the male half and female half ends of the snap fastener, thereby securing the ends of the material in a stretched condition and providing additional stretched elastic tension forces retaining the connector fully mated to the receptacle.

FIG. 2 is a schematic representation of the electric connector-to-receptacle retainer means in this example for retaining a corded connector engaging to a corded receptacle, and incorporating stretching elasticity of a flexible material of said means and incorporating hook-and-loop fasteners and incorporating snap fasteners, comprising:

FIG. 2a) illustrating the electric connector-to-receptacle retainer means flexible material including an installed hook-and-loop fastener to which a connector can be fastened and an installed hook-and-loop fastener to which a receptacle can be fastened and including a snap fastener with its male half, shown with a black center, imbedded on one end of said material and its female half, shown with a white center, imbedded on the other end of said material; and

FIG. 2b) illustrates the position on the flexible material that the connector is to be fastened by a hook-and-loop fastener and the position that the receptacle is to be fastened by a hook-and-loop fastener, wherein the hook-and-loop fasteners are located such that said material would need to be stretched to permit mating of said connector to said receptacle; and

FIG. 2c) illustrates the connector attached to the material and the receptacle attached to material such that by stretching longitudinally of the elastically flexible material allows the attached connector to be mating to the attached receptacle; and

FIG. 2d) illustrating the material released from its stretched condition but still with sufficient remaining stretching across the mated said connector and said receptacle to thereby provide a stretched elastic tension force retaining the connector fully mated to the receptacle; and

FIG. 2e) illustrating the stretching of the ends of the said material while folding them up and over the said mated connector and receptacle and the closing of the said snap fastener thereby fastening the ends together to provide by the stretched said ends, additional stretched elastic tension forces retaining the connector fully mated to the receptacle.

FIG. 3 is a schematic representation of the electric connector-to-receptacle retainer means in a two-piece format, in this example for use to retain a corded connector engaging with a duplex wall-receptacle, and incorporating stretching elasticity of a flexible material means and incorporating snap fasteners, comprising:

FIG. 3a) illustrates the corded connector half of the two-piece connecting retainer means comprising a flexible material, including an opening through which a corded connector has been inserted and including two snap fasteners, which in this example, are each the male half of snap fasteners shown with black centers; and

FIG. 3b) illustrates the wall receptacle half of a two-piece connecting retainer means including an opening to allow access to a wall receptacle for the engaging of a connector and includes two snap fasteners which are each the female half of snap fasteners shown with white centers and which said half of the retainer means is shown mounted horizontally in front of the upper receptacle of the said duplex but behind and secured by the wall cover plate which is fastened to the duplex receptacle with a securing screw; and

FIG. 3c) illustrates the engaging of a corded connector with the upper receptacle of the duplex wall receptacle, indicating the follow-up actions of stretching of the flexible material of each end of the connector connecting retainer material means over the sides of the connector while stretching of each of the ends of the receptacle connecting retainer material means over sides of the wall cover plate and over the stretched ends of the connector piece so as to align the male snap half with the female snap half and thereby allowing the closing of these snaps, one on each side of the connector; and

FIG. 3d) illustrates the said connector fully engaged with the said receptacle such that the closed snaps on each side of the connector have retained some of the stretching of the said ends of the receptacle retainer material means stretched over the edges of the wall cover plate and over the stretched material of the connector retainer material means thereby creating and maintaining stretched elastic tension forces retaining the connector fully mated to the receptacle.

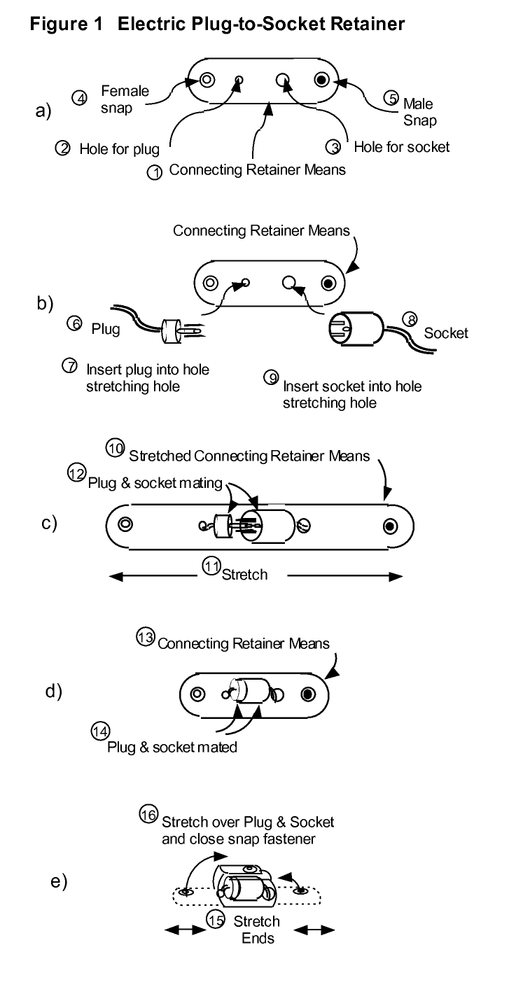

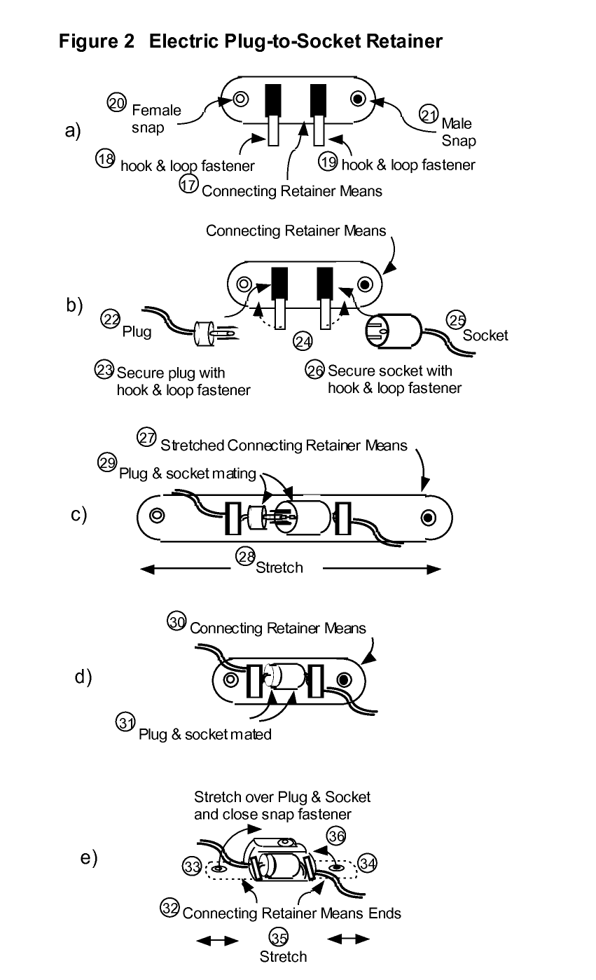

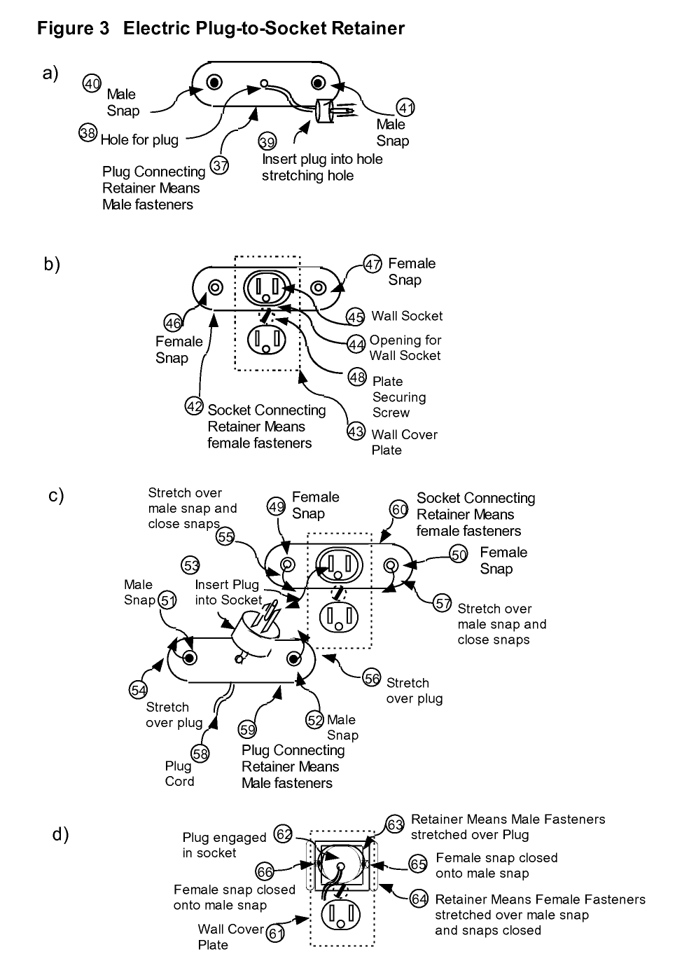

What we claim is:

1. A system for retaining a commonly available electric connector inserted into a commonly available electric receptacle for the prevention of the unintentional disconnection of said connector from said receptacle, comprising a retaining means for preventing said disconnection, and a securing device for attaching said means to said connector, and a securing device for attaching said means to said receptacle, and a releasing device for detaching said means from said connector, and a releasing device for detaching said means from said receptacle.

2. A system according to claim 1 wherein said receptacle and said connector are commonly available items such that no modifications to either are required in order to attach the said retaining means.

3. A system according to claim 1 wherein said means is a stretchable material such as but not limited to rubber, permitting its stretching to provide a force pulling together the said connector and said receptacle to prevent said disconnection.

4. A system according to claim 3 wherein said material incorporates an opening through which said connector can be inserted and an opening through which said receptacle can be inserted for which such stretching of the material not necessarily but can, also widen the said openings to receive the said connector and said receptacle and then return to original size to hold the connector and to hold the receptacle.

5. A system according to claim 4 wherein said material extends beyond said connector opening and extends beyond said receptacle opening such that retaining devices incorporated in these extensions can secure said extensions together.

6. A system according to claim 5 that said extensions when stretched can be secured by a securing device, to provide a force pulling together the said connector and said receptacle to prevent unintentional disconnection of said connector from said receptacle.

7. A system according to claim 5 wherein said securing device is a snap fastener of which the female half is affixed to one of the said extensions and the male half is affixed to the other said extension.

8. A system according to claim 5 wherein said securing device is a hook-and-loop type fastener of which one half is affixed to one of the said extensions and the other half is affixed to the other said extension.

9. A system according to claim 5 wherein said securing device is a tying device of which one half is affixed to one of the said extensions and the other half is affixed to the other said extension.

10. A system according to claim 5 wherein said securing means is provided by the length of said extensions being long enough to permit said extensions to be tied together.

11. A system according to claim 6 wherein said extensions are sufficiently long to permit the said connector end of said extension to be tied to the said receptacle end of said means, and said receptacle end of said extension to be tied to the said connector end of said means thereby provided said force.

12. A system according to claim 5 wherein said securing means is an independent tying device with which the said extensions can be secured individually.

13. A system according to claim 5 wherein said securing means is an independent tying device with which the said extensions can be secured together.

14. A system according to claim 1 wherein said means is a material of such length that when secured to said connector and secured to said receptacle with said securing devices the said material restricts movement of said connector and said receptacle to prevent said unintentional disconnection of said connector from said receptacle.

15. A system according to claim 1 wherein said material incorporates a retaining device with which said connector can be secured to said means and said material incorporates a retaining device with which said receptacle can be secured to said means.

16. A system according to claim 1 wherein said means comprises two material pieces of which one piece is attached to said connector and one piece is attached to said receptacle such that said material pieces can be retained on said connector and retained on said receptacle when said connector is said inserted to said receptacle, and when said connector is intentionally disengaged from said receptacle.

17. A system according to claim 16 wherein said material attached to said connector and said material attached to said receptacle each include devices incorporated into said material such that said devices prevent unintentional disconnection of said connector from said receptacle.

18. A system according to claim 17 wherein said means includes a releasing device in said connector material and a releasing device in said receptacle material for intentionally detaching said means from said connector and from said receptacle.
